(19) United States
(12) Patent Application Publication
(10) Pub. No.: US 2012/0300455 A1
(43) Pub. Date: Nov. 29, 2012

(54) Illumination Device

(75) Inventors: Nicole Breidenassel, Bad Abbach (DE); Guenter Hoetzl, Regensburg (DE); Fabian Reingruber, Muenchen (DE); Simon Schwalenberg, Donaustauf (DE)

(73) Assignee: OSRAM AG, Muenchen (DE)

(21) Appl. No.: 13/574,286

(22) PCT Filed: Jan. 18, 2011
(86) PCT No.: PCT/EP2011/050569

§ 371 Date: Jul. 20, 2012

(30) Foreign Application Priority Data
Jan. 20, 2010 (DE) 102010001047.2

(51) Int. Cl. F21V 7/20; F21V 29/00

(52) U.S. Cl. 362/235; 362/249.01; 362/249.02

(57) ABSTRACT

An illumination device may include a first heat sink; a carrier substrate, which is populated on its front side by at least one light source, and is attached by its rear side to the first heat sink; and a second heat sink, which is arranged essentially in front of the carrier substrate; wherein the at least one light source is arranged outside of the second heat sink.

The invention relates to an illumination device, in particular LED retrofit lamp.

One problem relating to LED lamps is the removal of dissipated heat from the light-emitting diodes (LEDs). Both the service life and the efficiency of the LEDs are increased by cooling. One of the main concerns when designing LED lamps is therefore to provide as large a cooling surface as possible. Replacement of a conventional incandescent bulb with an LED lamp (LED incandescent lamp retrofit lamp) involves problems as follows: in order to achieve (or at least approximate) a uniform radiation and a normal shape, a spherical diffuser or opaque lamp bulb is typically placed on top of the lamp. Only if this diffuser extends rearwards beyond the hemispherical shape, i.e. in the direction of a base section, does a small part of the light also radiate towards the rear (i.e. into a half-space to the rear), this being important for the emulation of a traditional incandescent lamp. However, the space that is required for the diffuser is then no longer used as a heat sink for cooling the LEDs. The shape of such a known diffuser therefore corresponds to a hemisphere or a spherical dome which is larger than the associated hemisphere. Use of diffusers made of plastic or glass is known.

The object of the present invention is to avoid one or more of the cited disadvantages and providing a means of improved cooling in particular, at the same time giving better distribution of light radiation in particular, a greater proportion thereof being directed to the side and/or into a half-space to the rear in particular.

This problem is solved according to the features in the independent claim. Preferred embodiments are derived from the dependent claims in particular.

The problem is solved by an illumination device including a first heat sink, a carrier substrate (e.g. a circuit board) which is populated on its front side by at least one light source and is attached at its rear side to the first heat sink, and a second heat sink, this being essentially arranged in front of the carrier substrate, wherein the at least one light source is arranged outside of the second heat sink.

The dissipated heat that is generated by the at least one light source and transferred into the carrier substrate can therefore also be removed on the other side of the carrier substrate via the second heat sink, as well as via the first heat sink. Cooling of the light source(s) is thereby improved without it being necessary to increase the size of the illumination device.

The term “arranged in front of the carrier substrate” means in particular an arrangement which is positioned further forwards or further towards a front end of the illumination device than the carrier substrate, relative to the longitudinal direction of the illumination device. The term “arranged outside of the second heat sink” means in particular an arrangement in which the at least one light source is arranged further outwards (radially) than the second heat sink at an essentially identical height or longitudinal position, relative to the longitudinal direction.

The carrier substrate may include a circuit board or printed circuit board, featuring a plastic, laminate or metal core in particular, and/or another carrier for the at least one light source, e.g. a submount or a module.

The carrier substrate can be fastened on its rear side to the first heat sink by a TIM (“thermal interface material”) such as an adhesive paste or a TIM film, for example. Alternatively or additionally, the carrier substrate can also be bonded and/or clamped.

The type of light source is not restricted and may include in particular a semiconductor light source such as a laser diode or light-emitting diode. If more than one light-emitting diode is present, they can radiate the same color or different colors. A color can be monochromatic (e.g. red, green, blue, etc.) or multichromatic (e.g. white). The light that is radiated by the at least one light-emitting diode can also be an infrared light (IR LED) or an ultraviolet light (UV LED). A plurality of light-emitting diodes can generate a blended light, e.g. a white blended light. The at least one light-emitting diode can contain at least one luminophore of changing wavelength (conversion LED). The at least one light-emitting diode be present in the form of at least one individually packaged light-emitting diode or in the form of at least one LED chip. A plurality of LED chips can be mounted on a shared substrate (“submount”). The at least one light-emitting diode can be equipped with at least one dedicated and/or shared lens system for beam control, e.g. at least one Fresnel lens, collimator, etc. Instead of or in addition to anorganic light-emitting diodes (e.g. based on InGaN or AlInGaP), organic LEDs (OLEDs, e.g. polymer OLEDs) can also be used in general.

The first heat sink and/or the second heat sink can consist of a material offering good thermal conductivity of at least 15 W/(m·K). In particular, the first heat sink and/or the second heat sink can consist of metal, in particular aluminum and/or copper or an alloy thereof.

According to an embodiment, the carrier substrate is populated by at least two light sources and the light sources are arranged symmetrically relative to the heat sink. The carrier substrate can be populated by at least two light sources, for example, and the second heat sink can be arranged at a common midpoint of the light sources. Uniform heat removal via the second heat sink can be achieved thus.

According to a further embodiment, the carrier substrate is populated by at least three light sources, which are arranged annularly around the second heat sink. It is thereby possible to achieve an effective heat removal in a compact embodiment of the second heat sink.

According to a further embodiment, the second heat sink is embodied as a reflector for the at least one light source. The light that is radiated from the light sources into a forward spatial region (“forwards”) in particular can therefore be redirected to the side and/or into a half-space to the rear without further components (and hence in a compact and economical manner). This better approximates the radiation characteristics of a conventional incandescent lamp.

The light sources can be so aligned that in particular they have a main beam direction or optical axis that is oriented directly forwards. In particular, the at least one light source can have an optical axis that is so aligned as to be parallel with a longitudinal axis of the illumination device.

Alternatively, the at least one light source can also be directed obliquely inwards or feature a large portion of obliquely radiated light, in order thereby to achieve a greater portion of laterally radiated light.

The reflecting region or the reflector can be a mirroring reflector and/or a diffuse reflector. The reflection properties can be achieved e.g. by means of surface treatment, painting, coating, etc. of the second heat sink.

According to a further embodiment, the first heat sink and/or the second heat sink has at least one cooling structure (cooling fin, cooling strut, cooling pin, etc.) in each case. This allows the first heat sink and/or the second heat sink to release heat more rapidly.

According to a further embodiment, the second heat sink has at least one annular or hollow cylindrical region or ‘ring’ extending upwards from the carrier substrate. It is thus possible to provide a stable configuration and a large surface area while adding little weight.

According to a further embodiment, the second heat sink can have a region that extends laterally over the ring and/or away from the ring. It is thus possible to achieve a larger surface area for removing the heat from the second heat sink.

According to a development, the second heat sink has a region (‘collar’) that extends laterally outwards over the ring.

According to a further embodiment, the laterally extending region covers the ring (‘cap’). The laterally extending region therefore extends not or not only outwards but also inwards and therefore at least partially covers the top surface of the ring or hollow cylindrical region of the second heat sink. In other words, the second heat sink can have an (inverted) pot-type shape with a cover or ‘cap’ placed on the annular region, and therefore corresponds in its basic shape to a hollow cylinder that is largely closed on one side. The outwardly extending collar can also be present in this case (as a part of the cap in particular), wherein the second heat sink therefore has an essentially ‘mushroom-shaped’ outer contour, for example. A particularly large cooling surface can be created thus. The cover can also prevent direct access to an internal space that is surrounded by the ring.

This arrangement can further assist the heat removal and is particularly effective if the cap and/or the laterally extending region is located at a forward end of the ring (i.e. at that end of the ring which is opposite to the contact end of the ring featuring the carrier substrate). This applies because a forward region in front of the at least one light source is often cooler than a region at or in the vicinity of the carrier substrate, and therefore an increase in the extent of the surface of the second heat sink in the cooler region allows more effective cooling.

Alternatively, the ring may include merely the laterally outwards extending region or collar, in particular a circumferential region, in particular in the form of a spherical layer or a segment of a circle. In particular, a continuous internal space of the ring may be present and not be covered, e.g. in order to allow improved cooling by means of a chimney effect.

If the second heat sink is so embodied as to be reflective, a further embodiment can provide for at least an outside of the second heat sink to be so embodied as to be at least partially reflective. This produces a particularly compact illumination device featuring improved cooling performance and improved lateral reflection of the emitted light of the at least one light source, this being advantageous for replacement of a general-purpose incandescent lamp in particular.

In particular, if the second heat sink is symmetrically surrounded by the light sources, a comparatively uniform light radiation is produced in a circumferential direction.

If the second heat sink features at least the collar, which is so configured as to be reflective on its outside or underside or rear side (facing the at least one light source), it is possible to increase lateral light radiation in particular, or even light radiation into the rear half-space, depending on the angle position of the collar. This allows the light radiation of a conventional illumination device, e.g. incandescent lamp, to be approximated even more closely.

In particular, if the second heat sink is equipped with a reflective collar having the shape of a spherical layer, it is also possible to increase light radiation downwards or into a lower half-space. This also allows the light radiation of a conventional illumination device, e.g. incandescent lamp, to be approximated even more closely.

According to a further embodiment, the carrier substrate is populated on its front side by at least one electronic component (e.g. driver module, resistor, etc.) and the at least one electronic component is surrounded by the second heat sink. In other words, the at least one electronic component can be laterally surrounded by the second heat sink. Heat that is emitted by the at least one light source and the at least one electronic component can be transferred to the second heat sink particularly effectively in this way. The at least one light source and the at least one electronic component can also be separated from each other in this way.

According to a further embodiment, the illumination device features a continuous air channel running from the first heat sink, through the carrier substrate and through the second heat sink. This makes it possible to achieve a chimney effect, whereby heat can be removed more effectively from the first heat sink and/or the second heat sink. This applies in particular to elements that are situated in the air channel.

In particular, the air channel in the second heat sink can be formed at least partially by an internal space of a ring or ring section that is open on both sides. In particular, the air channel can be arranged centrally.

On its side that faces away from the carrier substrate, the first heat sink can generally be connected to a base section or driver housing. The base section can feature in particular a housing section for accommodating a driver (driver cavity). The base section can feature an electrical connection (e.g. an

Edison thread), in particular at its end that faces away from the first heat sink. The base section, in particular an electrical connection, therefore corresponds to a rear end of the illumination device. A front end or ‘peak’ of the illumination device can be formed in particular by the second heat sink.

The first heat sink can feature a supporting region in particular, this being e.g. disc-shaped and provided for supporting the carrier substrate. Cooling struts, cooling fins, etc. can be provided on the side that faces away from the carrier substrate (rearwards), in particular extending vertically therefrom. In particular, the cooling struts, etc. can be arranged eccentrically and angled symmetrically relative to a longitudinal axis of the illumination device.

This embodiment of the heat sink allows an airflow to be generated between the cooling struts, etc., thereby providing particularly effective cooling. This airflow is also effective if the illumination device is oriented obliquely or horizontally.

According to a development, the base section bulges towards the front in a central region (relative to the longitudinal axis of the illumination device). The bulge can therefore extend in particular in the direction of or into the at least one cooling structure, particularly if said cooling structure features the eccentric and symmetrically angled cooling struts. An accumulation of heat at the base section and hence in the vicinity of the driver cavity is therefore prevented in the case of a downwards oriented installation of the illumination device, thereby further assisting a cooling effect.

According to an embodiment, the illumination device features at least one channel, e.g. a cable channel, which extends from a driver cavity through the first heat sink and through or past the carrier substrate. As a result of this, at least one electrical line (e.g. a cable) can be routed in a protected manner from the driver cavity to the carrier substrate, in particular to a top side of the carrier substrate.

The channel can run centrally (relative to the longitudinal axis), for example. To this end, the first heat sink can feature e.g. a centrally arranged sleeve-shaped region or guide tube, which is linked at the front to a central opening in the carrier substrate and which leads at the rear into the driver cavity, for example.

Alternatively, the course of the channel can be eccentric. For this, the first heat sink can feature e.g. an end-to-end hole in the cooling structure, in particular in at least one of the cooling struts or cooling fins, wherein said hole is linked at the front to an opening in the carrier substrate, and leads at the rear into the driver cavity, for example.

In particular, the eccentric channel can extend into the second heat sink and laterally from there, laterally outwards in particular. The channel can be separated from the internal space of the second heat sink in the context of this embodiment, in order to allow an unrestricted layout of the internal space, e.g. as an air channel and/or for storage of components.

According to a further embodiment, the illumination device features at least one channel, which is linear in particular (e.g. a screw hole) and extends at least through the second heat sink, through or past the carrier substrate, and onwards through the first heat sink as far as the base section. The base section can feature a fastening structure, in particular a screw thread, for engagement with the fastening element. It is thereby possible to introduce a fastening element, e.g. a screw, from the outside through the second heat sink and then into the channel. The base section, the first heat sink, the second heat sink and possibly the cover (see below) can therefore be held together (in particular clamped together) by the at least one fastening element.

According to a specific embodiment, the illumination device features at least two (in particular at least three) of these (linear) channels, which can be symmetrically angled relative to the longitudinal axis of the illumination device. A particularly stable connection can be achieved thus.

The linear channel can run within the first heat sink, in particular within a cooling strut, etc. The cooling strut can be specially designed for this purpose, e.g. be wider in order to provide an adequate wall thickness.

A channel can also be combination of a channel that opens into the driver cavity, e.g. a cable channel, and a channel that serves as a screw hole. Alternatively, the second heat sink can be connected to the first heat sink, in particular by means of a screw connection, and the first heat sink can be separately connected to the base section, in particular by means of a screw connection.

According to a further embodiment, the illumination device features a translucent cover, in particular a diffuser, which extends between the first heat sink and the second heat sink and, in conjunction with these, forms a hollow space for at least the LED module. The cover can serve as a protective cover, e.g. as a lamp bulb. The embodiment as a diffuser provides greater homogenization of a light radiation of the illumination device.

The cover can be held or locked in position by the first heat sink and the second heat sink, e.g. gripped between them. The cover can be fitted e.g. into a corresponding recess (e.g. a groove) of the first heat sink and/or of the second heat sink, and to this end can feature in particular a corresponding projection in each case, e.g. a rim that surrounds it at least partially.

For the purpose of assembly, for example, the cover can first be connected to (e.g. inserted into) the second heat sink and the connected element can then be mounted on the illumination device. The second heat sink can therefore be considered as part of a special cover, wherein the second heat sink overlaps or replaces a corresponding part of the translucent material of the cover.

According to a further embodiment, the cover can first be placed loosely onto the first heat sink and then the second heat sink can be placed onto the carrier substrate and/or onto the first heat sink. The first heat sink and the second heat sink can then be pushed together or drawn together, e.g. by means of a threaded joint, whereby the cover is clamped or squeezed between the first heat sink and the second heat sink. Such an assembly is easy and can be performed without further resources.

According to a further embodiment, the basic shape of the cover has the form of a spherical layer, e.g. including an attachment rim and/or a recess, wherein the cover is fastened onto the first heat sink by means of e.g. the attachment rim, and the recess accommodates the second heat sink.

Alternatively, the second heat sink can adjoin a surface of the cover, either providing a gap (preferably a gap of less than 1 mm) or being in contact with the cover. It is therefore not essential for the second heat sink to be exposed to the environment, and the second heat sink can instead release heat outwards through the cover. The cover can arch over the second heat sink, for example. The cover can also feature a cavity in order to allow a chimney effect.

The translucent material of the cover can be made of plastic, glass or ceramic. In particular, the plastic can be a thermally conductive and translucent plastic having sufficient temperature stability, such as e.g. polycarbonate. According to an embodiment that is optimized for better thermal conductivity, the translucent material includes a plastic that is filled with particles having higher thermal conductivity. Alternatively, the cover may include glass, in particular a thermally conductive glass having a thermal conductivity of more than 1.1 W/(m·K), e.g. Borofloat with 1.2 W/(m·K). Alternatively, the translucent material may include a transparent ceramic (e.g. a transparent aluminum oxide ceramic), which can have far higher thermal conductivities. By virtue of the greater thermal conductivity of the cover, heat can easily be released through it into the ambient air.

Instead of a diffuser, it is also generally possible to use a transparent cover, wherein said transparent cover can be embodied as described above in relation to the diffuser (as a cover that scatters in a diffuse manner).

According to a further development, the second heat sink is arranged on the carrier substrate. The first heat sink and the second heat sink need not abut in this case.

According to an alternative development, the first heat sink and the second heat sink abut through a central cavity in particular, of an annular carrier substrate in particular. This allows accurate positioning (in particular centering) of the carrier substrate.

According to a specific development, the first heat sink and the second heat sink abut in a coded manner, e.g. engage with each other in an interlocking manner. It is therefore possible in a simple manner to establish an angle position of the two heat sinks relative to each other, this being advantageous e.g. when aligning a screw hole which passes through the two heat sinks. In addition, the carrier substrate can also abut at least one of the heat sinks in a coded manner, e.g. by means of a suitable embodiment of an inner rim of the carrier substrate and e.g. an outer circumferential surface of the annular region of the first heat sink and/or of the second heat sink.

According to a further embodiment, the illumination device is an LED incandescent lamp retrofit lamp. The (transparent or diffusely scattering) cover can then be embodied e.g. externally in essentially the form of a spherical dome. Since the illumination device is an LED incandescent lamp retrofit lamp, the illumination device can correspond in respect of its external contour to in particular the traditional all-purpose incandescent lamp, without a concentration of light beams, that it is to replace.

The LED incandescent lamp retrofit lamp has an external contour that is essentially radially symmetrical relative to the longitudinal axis. At one end of the LED incandescent lamp retrofit lamp is the base section including at least two electrical contacts, wherein the base section can be embodied as an E14, E27 or bayonet base section or have a different shape, and wherein said base section allows fastening and contacting of the illumination device in a socket. Said base section defines the rear end of the illumination device in particular.

In respect of an LED incandescent lamp retrofit lamp in particular, it can be advantageous to arrange the carrier substrate in front of the widest point of the illumination device (the ‘equator’).

However, all existing LED retrofit incandescent lamps have the LED circuit board situated either at the equator, i.e. exactly at the widest point of the LED retrofit incandescent lamp, or even behind the equator, i.e. in the region that can be referred to as the neck of the incandescent lamp. This has the disadvantage that the first heat sink is made unnecessarily smaller as a result. The first heat sink is however particularly large in the proposed embodiment and therefore, in addition to an improved cooling effect, the driver substrate is also particularly far away from the base section and the driver electronics that are housed therein. This has a positive effect in that the at least one light source and the driver electronics are better thermally isolated from each other, this being particularly desirable: in the power range up to 20 W, the driver electronics typically develop no local dissipated heat of any practical consequence, and therefore can almost be left uncooled. If a first heat sink is (too) small, the driver electronics can be heated by the at least one light source to a greater extent than they are cooled by the first heat sink. The first heat sink then degenerates into a heat conductor which, in addition to frequently inadequate cooling of the light source(s), represents a problem in all existing LED retrofit incandescent lamps.

With regard to the second—reflective—heat sink, it is indeed essential for the carrier substrate to be located in front of the ‘equatorial plane’, since the illumination density directly forwards axially would otherwise be too weak. Finally, this geometry makes it easy for the translucent and optionally opaque diffuser, having the shape of a spherical washer, to be simply clamped between first and second heat sinks.

By virtue of the illumination device described here, the surface area that is available for cooling becomes larger. It is consequently possible to create illumination devices having greater power and greater brightness. By virtue of the reflector and the arrangement of the second heat sink and the translucent cover, it is possible to ensure approximately uniform illumination. The space in the direction of the base section is included in this case.

In the following figures, the invention is schematically described in greater detail with reference to exemplary embodiments. For the sake of clarity, identical or functionally identical elements may be denoted by identical reference signs.

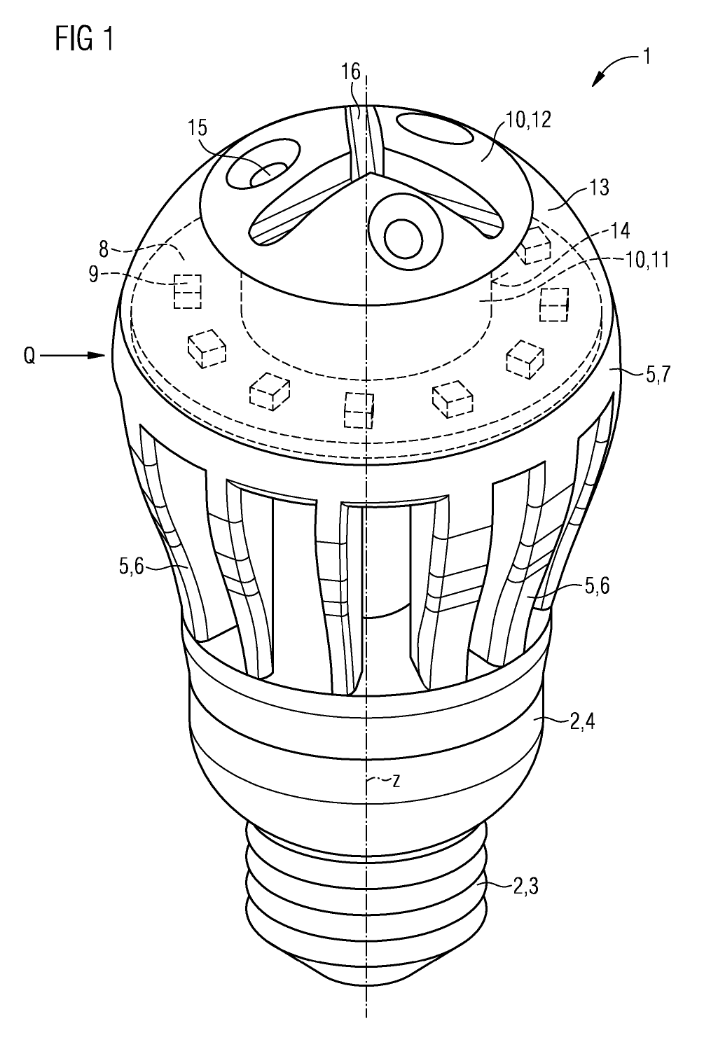

FIG. 1 shows an LED incandescent lamp retrofit lamp according to a first exemplary embodiment in an oblique side view;

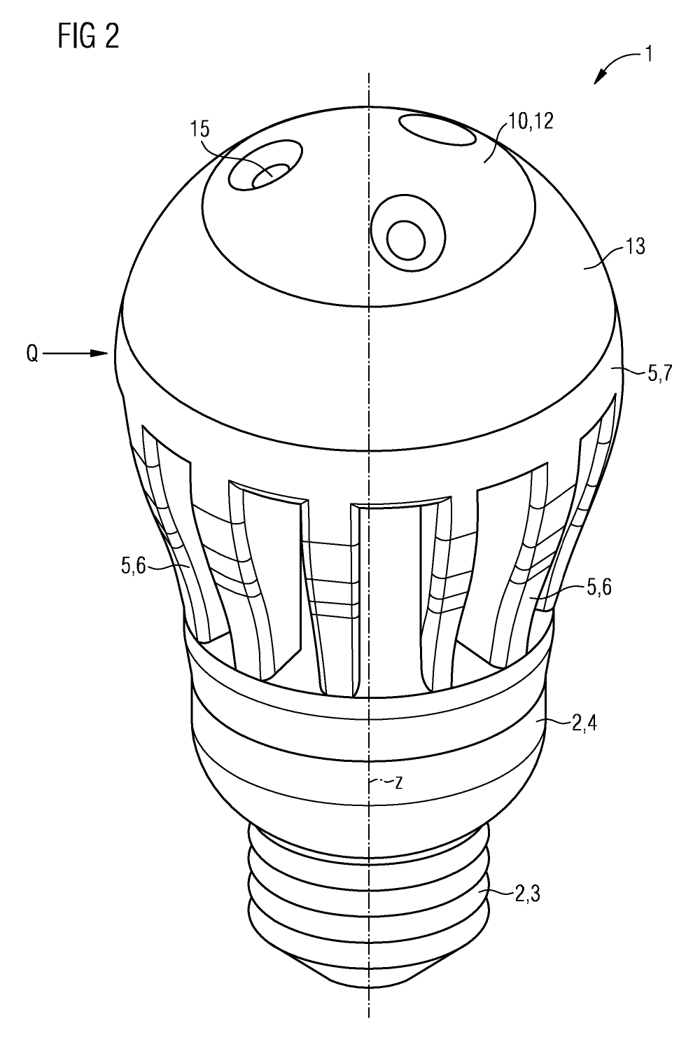

FIG. 2 shows the LED incandescent lamp retrofit lamp according to the first exemplary embodiment as an outline image in a view that is similar to that in FIG. 1;

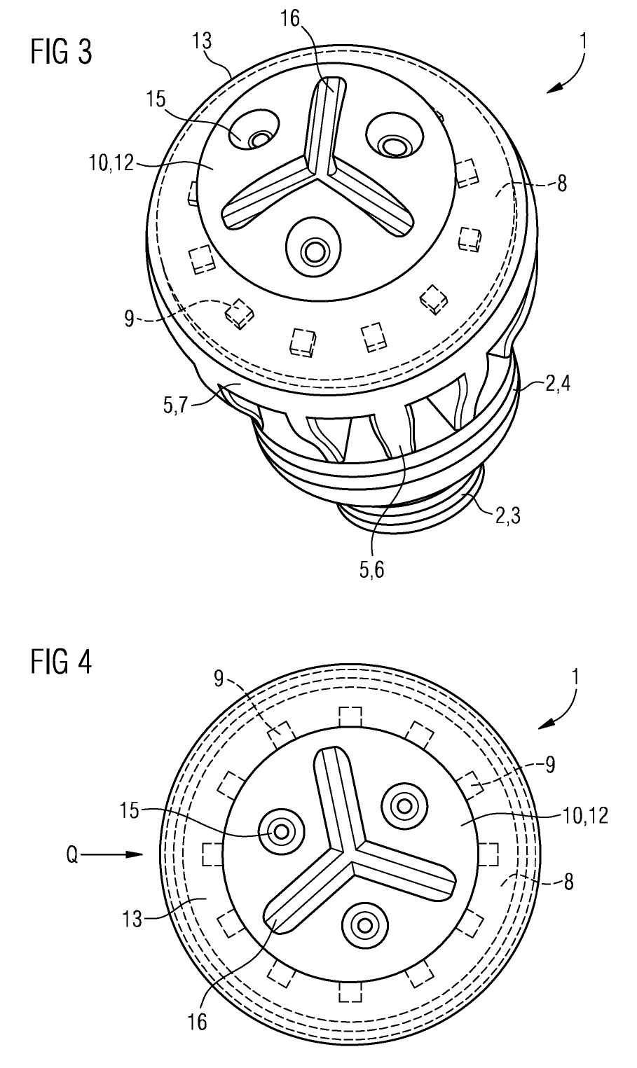

FIG. 3 shows a section from the LED incandescent lamp retrofit lamp according to the first exemplary embodiment in an oblique top view;

FIG. 4 shows an extract from the LED incandescent lamp retrofit lamp according to the first exemplary embodiment in a plan view;

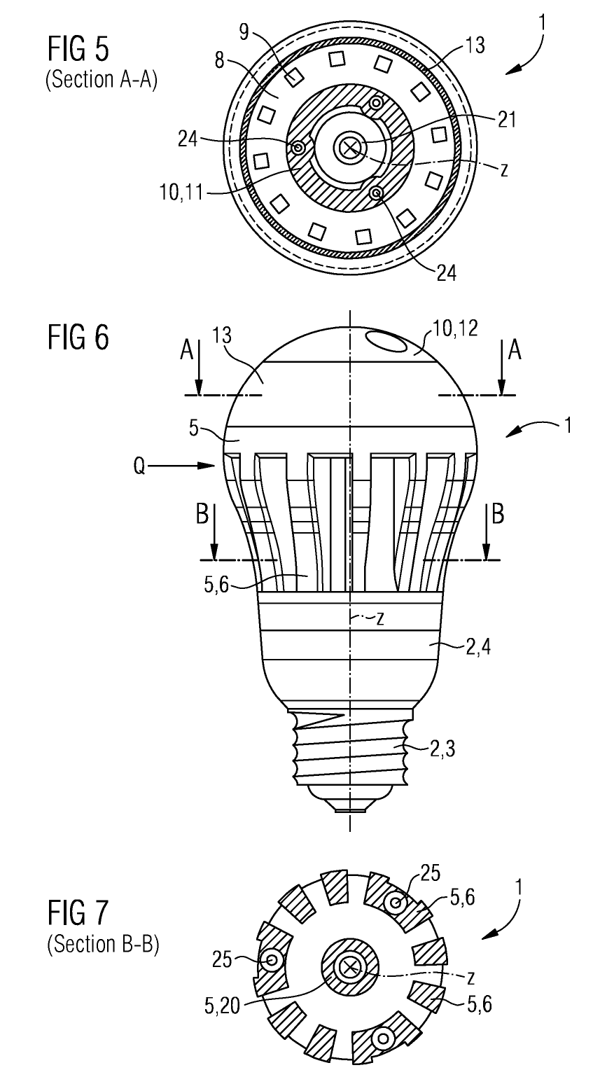

FIG. 5 shows the LED incandescent lamp retrofit lamp according to the first exemplary embodiment in a plan view of a section A-A shown in FIG. 6;

FIG. 6 shows the LED incandescent lamp retrofit lamp according to the first exemplary embodiment with two section lines A-A and B-B;

FIG. 7 shows the LED incandescent lamp retrofit lamp according to the first exemplary embodiment in a plan view of the section B-B shown in FIG. 6;

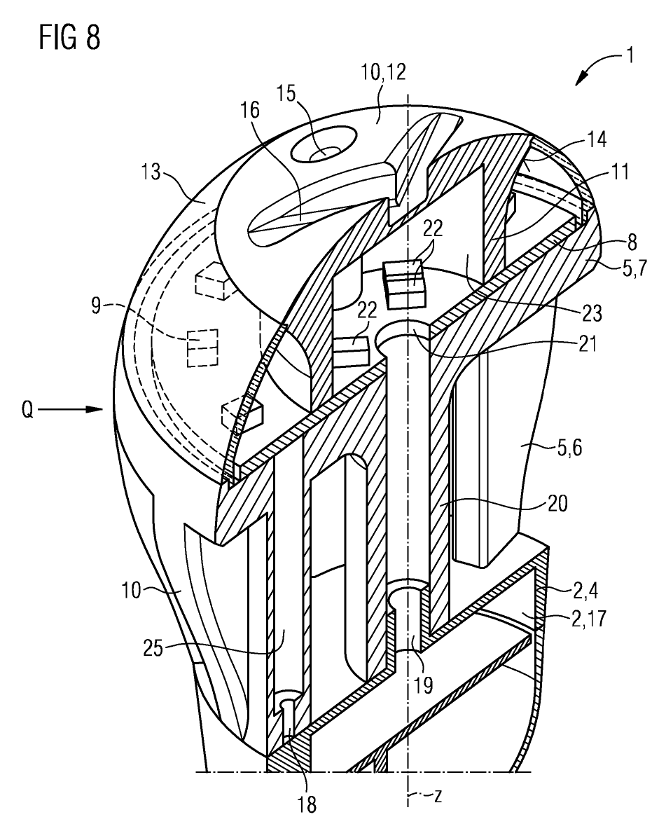

FIG. 8 shows an extract from the LED incandescent lamp retrofit lamp according to the first exemplary embodiment as a cutaway in an oblique view;

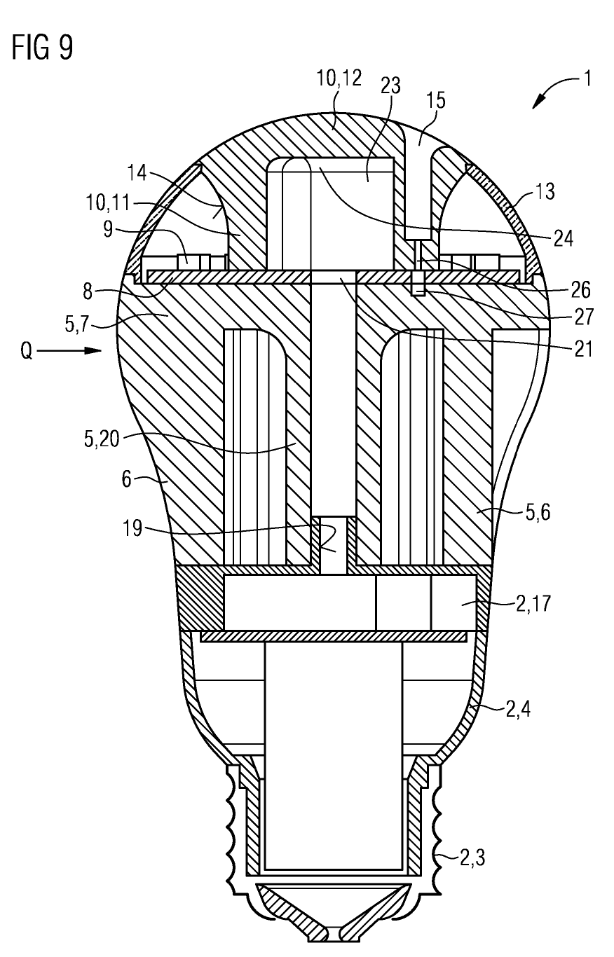

FIG. 9 shows the LED incandescent lamp retrofit lamp according to the first exemplary embodiment as a cutaway in a side view;

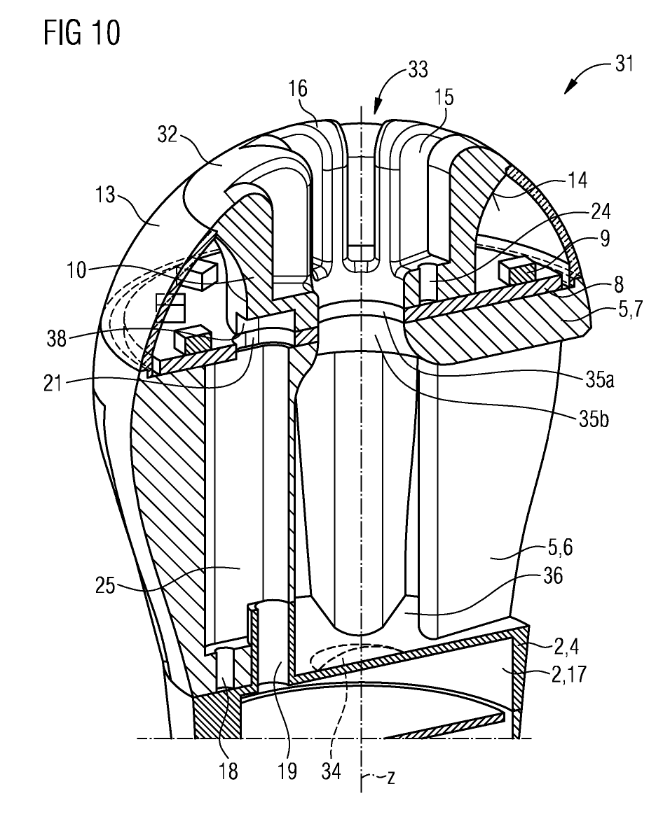

FIG. 10 shows an extract from an LED incandescent lamp retrofit lamp according to a second exemplary embodiment as a cutaway in an oblique view;

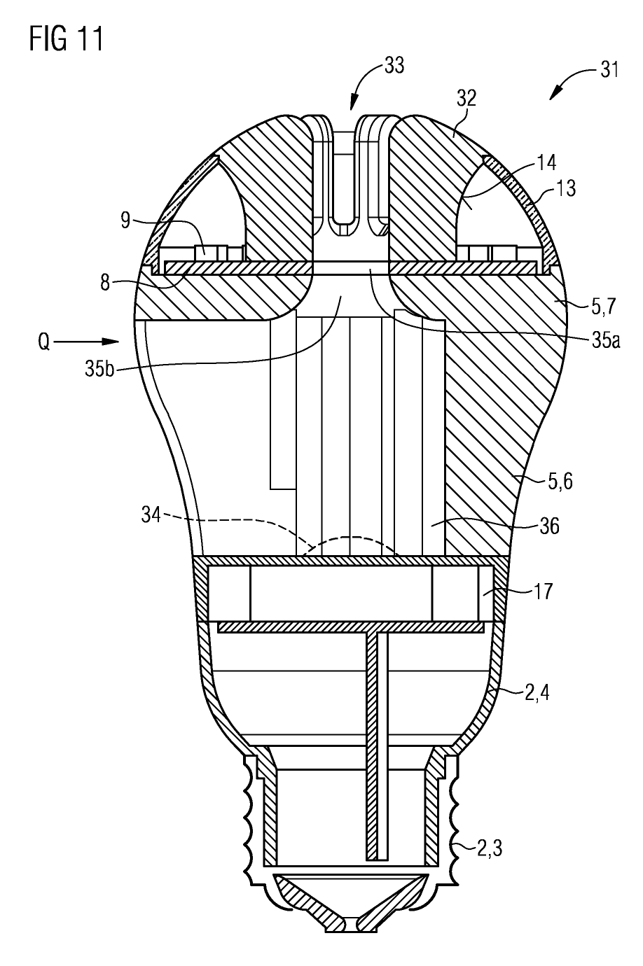

FIG. 11 the LED incandescent lamp retrofit lamp according to the second exemplary embodiment as a cutaway in a side view;

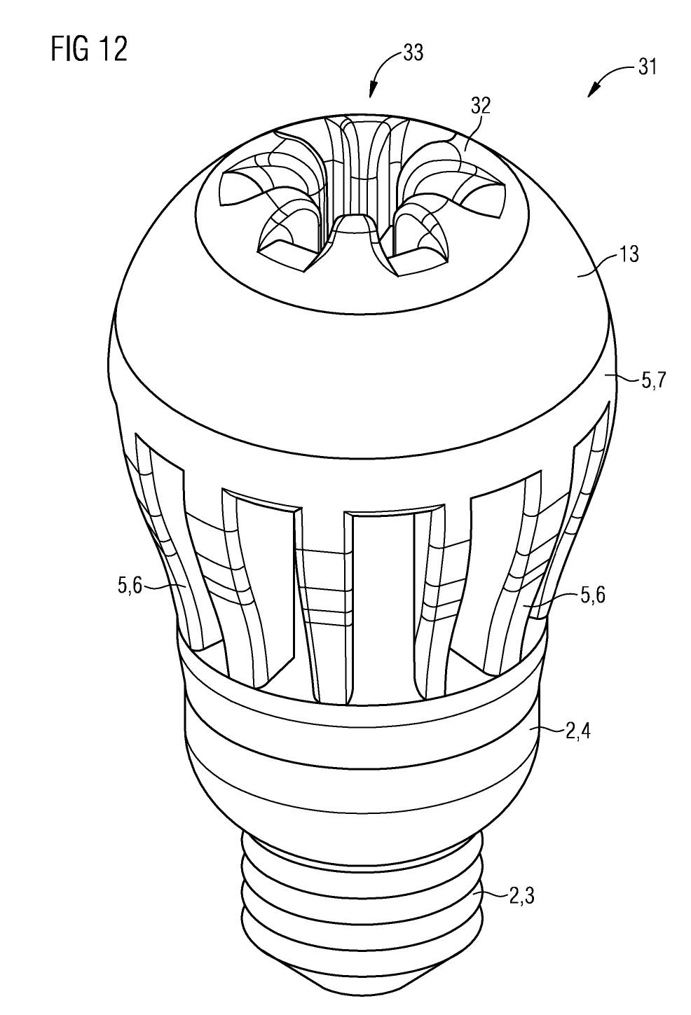

FIG. 12 shows the LED incandescent lamp retrofit lamp according to the second exemplary embodiment in an oblique view as an outline image;

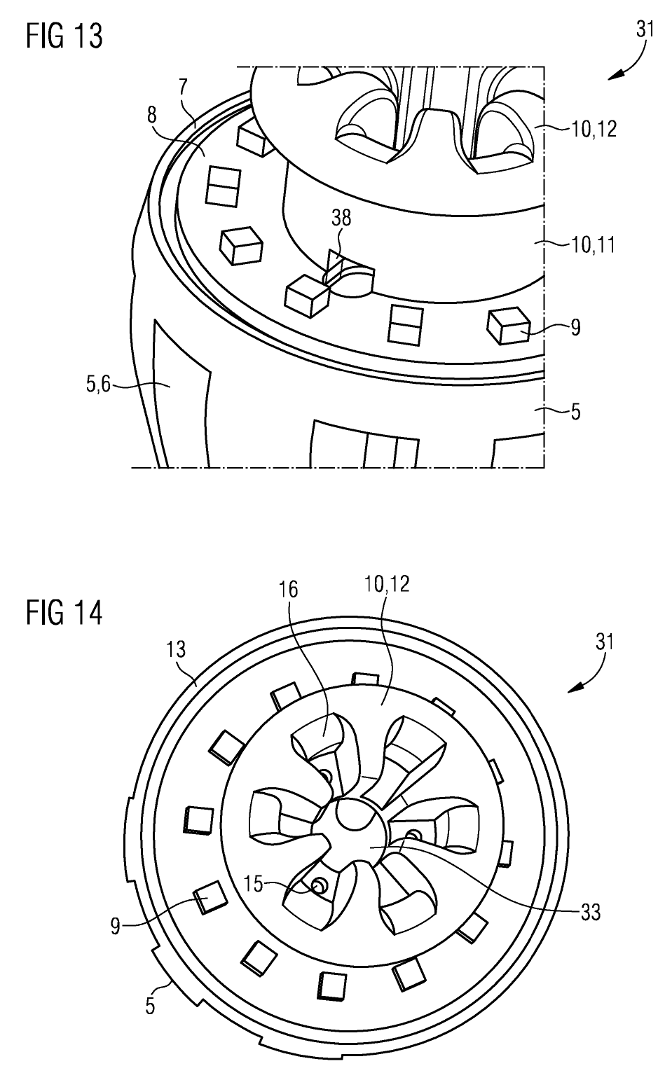

FIG. 13 shows an extract from the LED incandescent lamp retrofit lamp according to the second exemplary embodiment in a region of a first heat sink in an oblique view; and

FIG. 14 shows the LED incandescent lamp retrofit lamp according to the second exemplary embodiment in an oblique top view.

An illumination device in the form of an LED incandescent lamp retrofit lamp 1 according to a first exemplary embodiment is shown in FIG. 1 in an oblique side view, in FIG. 2 in an oblique side view as a simplified outline image, in FIG. 3 in an oblique top view, in FIG. 4 in a plan view, and in FIG. 6 in a side view.

The LED incandescent lamp retrofit lamp 1 features a base section 2, which is situated at the rear and has an Edison thread 3 for screwing into a conventional Edison incandescent lamp socket for a power supply. In front of the Edison thread 3 (further in the direction of the z-axis that also corresponds here to the longitudinal axis of the LED incandescent lamp retrofit lamp 1), the base section 2 features a housing section 4 for accommodating at least part of a driver (not shown). The driver is supplied with current via the Edison thread 3.

A first heat sink 5 is located on the base section 2 and features nine rearwards or backwards (against the z-direction) facing cooling struts 6, these being so arranged as to be radially symmetrical about the longitudinal axis or z-axis z of the LED incandescent lamp retrofit lamp 1, as shown in

FIG. 7 also. The cooling struts 6 are so arranged as to be symmetrically angled and eccentric relative to the longitudinal axis or z-axis z of the LED incandescent lamp retrofit lamp 1. In other words, the cooling struts 6 are located on the base section 2 at their rear end (that end which is arranged further back along the z-axis z). The cooling struts 6 do not have an identical format; every third cooling strut 6 is instead widened in order that an end-to-end hole 25 (see also FIG. 8) can be enclosed therein. These widened cooling struts 6 can be formed of two narrower cooling struts 6, whose intermediate space is filled with material and contains the hole 25, see FIG. 7.

The cooling struts 6 are connected together at their front ends as mutually integral parts via a disc-shaped supporting region 7, and are positioned on the base section 2 at their rear ends. A carrier substrate in the form of an annular LED circuit board 8 is attached (e.g. bonded and/or pressure-fixed) onto the front side (that side which faces in a longitudinal direction) of the supporting region 7.

The LED circuit board 8 is therefore attached at its rear side to the first heat sink 5, specifically to the supporting region 7 of the first heat sink 5. The LED circuit board 8 is populated on its front side by a plurality (twelve in this case) of light-emitting diodes 9 which can have a main beam direction that is oriented forwards in a z-direction (e.g. so-called ‘top LEDs’) as shown in FIG. 5 also.

The light-emitting diodes 9 are arranged symmetrically and annularly around a second heat sink 10, which is mounted on the front side of the LED circuit board 8. The second heat sink 10 projects upwards from the LED circuit board 8 and/or extends outwards over the light-emitting diodes 9 at its front. The second heat sink 10 features a region or ring 11 in the shape of a circular (hollow) cylinder, which is situated on the LED circuit board 8. The ring 11 has an inner circumferential surface in the shape of a circular cylinder.

At the forward end of the ring 11, it widens laterally inwards and outwards, as also shown in FIG. 8 and FIG. 9. In other words, the annular region or ring 11 of the second heat sink 10 is covered by a cap 12, which includes both a region (‘lid’) covering the top of the ring 11 and a collar that extends laterally outwards. The cap 12 has an external contour in the form of a spherical dome. The cap 12 also features vertical screw holes 15 and an assembly recess 16.

The ring 11 and the cap 12 of the second heat sink 10 are formed as a unitary part, e.g. by means of a metal casting method. The second heat sink 10 can be equipped with cooling fins or other cooling structures. The LED circuit board 8 is therefore mechanically and thermally in contact on both sides with the heat sinks 5 and 10. This allows particularly effective removal of heat from the LED circuit board 8 and cooling of the light-emitting diodes 9, and a particularly compact design. In particular, the LED circuit board 8 can be positioned higher than in the case of conventional retrofit lamps, in particular above (further in a z-direction) the widest point Q (the ‘equator’) of the LED incandescent lamp retrofit lamp 1, thereby creating more space and cooling surface for the first heat sink 5.

The second heat sink 10 is additionally so embodied as to be partially reflective (in a diffuse or mirroring manner), such that light radiated from the light-emitting diodes 9 is partially reflected thereon. In particular, the outside 14 of the second heat sink 10 can be reflective. Since the light-emitting diodes 9 are arranged laterally outside of the second heat sink 10, i.e. the second heat sink 10 is located centrally between the light-emitting diodes 9, the light that is radiated from the light-emitting diodes 9 onto the outer circumferential surface 14 is reflected inter alia laterally outwards. A diffuse reflection (scattering) produces a more homogeneous light radiation in this case. The more the outer circumferential surface 14, in particular in the region of the cap 12, is inclined outwards relative to the longitudinal axis, the more the LED incandescent lamp retrofit lamp 1 can also radiate significantly to the rear (into the rear half-space).

The main beam direction of the LED incandescent lamp retrofit lamp 1 is nonetheless primarily directed towards the front (in a z-direction), since the light-emitting diodes 9 are not or at least not completely covered by the second heat sink 10 in the plan view (see also FIG. 4). As a result of the shadow thrown by the second heat sink 10, a conical region is produced in front of the LED incandescent lamp retrofit lamp 1 in this case, wherein said conical region is not directly illuminated by the light-emitting diodes 9. The peak of this shadow can be varied by the distance of the light-emitting diodes 9 from the center or longitudinal axis and by the diameter of the second heat sink 10, in particular the cap 12 thereof. As part of the design, the degree of overlap can generally be adjusted without restriction. Light can be radiated into this region indirectly by means of a diffuser 13 (see below).

If the LED incandescent lamp retrofit lamp 1 is tilted, the light flux in the (spatial) z-direction decreases with the angle of inclination. In addition to said variation of the main beam direction, this also occurs as a result of partially covering the light-emitting diodes 9. The shape of the second heat sink 10 can be adapted generally to the optical requirements in respect of illumination.

In order to give greater homogenization to the light flux and provide a protection against damage, the LED incandescent lamp retrofit lamp 1 also features a milk-white diffuser 13 made of plastic or glass and having the shape of a spherical layer. A central cavity of the diffuser 13 contains the second heat sink 10, and a rim of the diffuser 13 is located on the first heat sink 5. The diffuser 13 and the second heat sink 10 can also be combined as a cover element and then mounted on the LED incandescent lamp retrofit lamp 1. The cover element then corresponds to a lamp bulb having a less than hemispherical contour in this case and having an only partially translucent surface and functioning as a heat sink and/or reflector. The diffuser 13 can be positioned by means of a chamfer in the heat sinks 5, 10, and locked into position by means of a groove, for example.

FIG. 8 shows an extract from the LED incandescent lamp retrofit lamp 1 as a cutaway in an oblique view, and FIG. 9 shows the LED incandescent lamp retrofit lamp 1 as a cutaway in a side view. The housing section 4 contains a storage space 17 for the driver (not shown) that operates the light-emitting diodes 9. The electrical lines (not shown), such as wires or cables between the driver and the LED circuit board 8, run from the driver cavity or the housing section 4 through a central channel (cable channel), which is formed by an upper connection piece 19, a guide tube 20 of the first heat sink 5 and a guide opening 21 in the LED circuit board 8. Further electronic components 22 in addition to the light-emitting diodes 9 are present on the LED circuit board 8.

The cap 12 is flat in its region (lid) covering the ring 11, such that the cap 12, the ring 11 with its inner circumferential surface and the LED circuit board 8 form an essentially cylindrical hollow space 23. The electronic components 22 (e.g. driver modules) are located on the LED circuit board within the hollow space 23 and are therefore mechanically separate from the light-emitting diodes 9 on the outside and are also protected against direct access.

For the purpose of assembling the illumination device 1, the first heat sink 5 features a vertically continuous hole 25 in each of three symmetrically angled cooling struts 6, as also shown in FIG. 7. The holes 25 narrow in each case to a screw hole 18 at the base section. In order to connect the first heat sink 5 to the base section 2, the first heat sink 5 can be positioned on the base section 2 (or vice versa) first, then a screw (not shown) is inserted into the hole 25 from above and its shaft is passed through the screw hole 18, wherein the screw hole 18 provides a thrust bearing for the screw head. The screw can then be screwed into the base section 2. The base section 2 can have a threaded or an unthreaded screw hole (not shown) for this purpose. Alternatively, the screw can be self-tapping, such that a screw hole can even be omitted (e.g. a blind hole). The thread of the at least one self-tapping screw then cuts into a corresponding counterpart of the base section 2, for example. A particularly advantageous form of screw is a self-tapping Allen screw or Torx screw that has a long smooth shaft whose diameter should correspond to at least the external diameter of the thread. In this way, the at least one screw can also be used for centering.

In order to connect the second heat sink 10 to the first heat sink 5, the second heat sink 10 likewise features vertical end-to-end screw holes 15, which pass through the cap 12 and the annular region 11 and narrow at the end facing the carrier substrate 8 or the first heat sink 5 to form a screw hole 24 (see FIG. 9). In alignment with the respective screw hole 24, a screw hole 26 is provided in the carrier substrate and a blind hole 27 is provided in the supporting region 7 of the first heat sink 5. The blind hole 27 can be threaded or unthreaded.

In order to connect the first heat sink 5 to the second heat sink 10, the second heat sink 10 can first be positioned on the LED circuit board 8 (or vice versa), then a screw (not shown) is inserted into the screw hole 15 from above and its shaft is passed through the screw hole 26. The screw can then engage in the blind hole 27 by means of screwing.

The diffuser 13 can be placed onto the first heat sink before the second heat sink 10 is attached, such that the diffuser 13 can be firmly clamped between the two heat sinks 5, 10 by tightening the screw(s) after the second heat sink 10 is attached.

FIG. 10 shows an extract from an LED incandescent lamp retrofit lamp 31 according to a second exemplary embodiment as a cutaway in an oblique view, FIG. 11 shows the LED incandescent lamp retrofit lamp 31 as a cutaway in a side view, FIG. 12 shows the LED incandescent lamp retrofit lamp 31 in an oblique view, FIG. 13 shows an extract from the LED incandescent lamp retrofit lamp 31 without the diffuser 13 in a supporting region 7 of the first heat sink 5 in an oblique view, and FIG. 14 shows the LED incandescent lamp retrofit lamp 31 in an oblique top view.

Unlike the incandescent lamp retrofit lamp 1 according to the first embodiment, the second heat sink 32 now features a central vertical end-to-end air through-channel 33. The air through-channel 33 features laterally positioned assembly recesses 16 and screw holes 15 for assembling the second heat sink 32. The screw holes 15 differ from the assembly recesses 16 solely in respect of the screw holes 24 that extend downwards or rearwards.

The air through-channel 33 of the second heat sink 32 is situated congruently above a cutout in the LED circuit board 8, said cutout serving as an air through-opening 35a, and an through-opening 35b in the supporting region 7 of the first heat sink 5, thereby providing an end-to-end air channel 33, 35a, 35b from the top of the second heat sink 10 to an underside of the supporting region 7. Since a guide tube 20 is no longer present, the channel 33, 35a, 35b opens rearwards into an open airspace 36, which is surrounded at intervals by the cooling struts 6. During operation in a vertical or oblique position of the incandescent lamp retrofit lamp 31, the warming up of the second heat sink 10 can therefore create a chimney effect in which air is increasingly drawn from the open airspace 36 through the air through-channel 33 (or vice versa if the orientation is reversed), thereby producing improved cooling.

In order to guide the electrical line(s) from the driver to the LED circuit board 8, the cable channel is now combined with one of the holes 25 which runs through one of the cooling struts 6 upwards to the LED circuit board 8. For this purpose, this one hole 25 is widened and the connection piece 19 is arranged eccentrically such that it projects into this hole 25 from below or behind. In addition to the central air through-opening 35a, the LED circuit board 8 therefore now features a laterally offset (eccentric) guide opening 21, which leads into a laterally open cavity 38 in the second heat sink 32 as a cable guide.

As shown in FIG. 10 and FIG. 11, the base section 2 can bulge towards the front in a central region (relative to the longitudinal axis). The bulge 34 therefore extends forwards in the direction of the cooling strut(s). If the LED incandescent lamp retrofit lamp 31 is installed in a downwards oriented manner, this prevents an accumulation of heat at the base section 2 and hence in the vicinity of the storage space 17 (driver cavity), thereby further assisting a cooling effect.

The present invention is obviously not restricted to the exemplary embodiments shown.

It is therefore possible also to use light sources other than light-emitting diodes.

The illumination device can also relate to different types of retrofit lamp, e.g. a halogen beam retrofit lamp, a lighting fixture, a system of lighting fixtures or a part thereof.

The diffuser can also arch over the second heat sink.

The first heat sink and the second heat sink can also abut, particularly in a coded manner. For this purpose, e.g. the air through-opening 35a in the LED circuit board 8 according to the second exemplary embodiment can be wider than the air through-channel 33 and the through-opening 35b in the first heat sink 5 of the second exemplary embodiment, such that e.g. the rim of the second heat sink 32 and/or the first heat sink 5 can extend or project through the air through-opening 35a. For the purpose of coding, e.g. in order to maintain a relative angle position or orientation, the second heat sink 32 and the first heat sink 5 can engage with each other in an interlocking or intermeshing manner, for example.

The illumination device or parts thereof can also be fastened together by means of at least one central screw.

### LIST OF REFERENCE SIGNS

1 LED incandescent lamp retrofit lamp
2 Base section
3 Edison thread
4 Housing section
5 First heat sink
6 Cooling strut
7 Supporting region
8 LED circuit board
9 Light-emitting diode
10 Second heat sink
11 Ring
12 Cap
13 Diffuser
14 Outer circumferential surface
15 Screw hole
16 Assembly recess
17 Storage space
18 Screw hole
19 Connection piece
20 Guide tube
21 Guide opening
22 Electronic component
23 Hollow space
24 Screw hole
25 Hole
26 Screw hole
27 Blind hole
31 LED incandescent lamp retrofit lamp
32 Second heat sink
33 Air through-channel
34 Bulge
35a Air through-opening in the LED circuit board
35b Air through-opening in the first heat sink
36 Open airspace
38 Cavity in the second heat sink
z z-axis/longitudinal axis

1. An illumination device, comprising:
a first heat sink;
a carrier substrate, which is populated on its front side by at least one light source, and is attached by its rear side to the first heat sink; and
a second heat sink, which is arranged essentially in front of the carrier substrate;
wherein the at least one light source is arranged outside of the second heat sink.

2. The illumination device as claimed in claim 1, wherein the carrier substrate is populated by at least two light sources and said light sources are arranged symmetrically relative to the second heat sink.

3. The illumination device as claimed in claim 1,
wherein the second heat sink is embodied as a reflector for the at least one light source.

4. The illumination device as claimed in claim 1,
wherein the second heat sink features at least one annular region which extends upwards from the carrier substrate.

5. The illumination device as claimed in claim 4, wherein the second heat sink features a region that extends at least laterally outwards from the annular region.

6. The illumination device as claimed in claim 3,
wherein the second heat sink features at least one annular region which extends upwards from the carrier substrate;
wherein at least an outside of the second heat sink is so embodied as to be at least partially reflective.

7. The illumination device as claimed in claim 1,
wherein the first heat sink features at least one cooling structure.

8. The illumination device as claimed in claim 7,
wherein the at least one cooling structure is mounted at its rear region on a base section and the base section bulges towards the front in a central region.

9. The illumination device as claimed in claim 8,
wherein the carrier substrate is populated on its front side by at least one electronic component and the at least one electronic component is surrounded by the annular region of the second heat sink.

10. The illumination device as claimed in claim 9,
wherein the illumination device features a continuous air channel from the first heat sink through the carrier substrate and through the second heat sink.

11. The illumination device as claimed in claim 10,
wherein the illumination device features a guide through the first heat sink and through the carrier substrate into the second heat sink, wherein the guide emerges to the side in the second heat sink.

12. The illumination device as claimed in claim 11,
wherein the illumination device features a cover, which extends between the first heat sink and the second heat sink and forms a hollow space for a light emitting diode module at least.

13. The illumination device as claimed in claim 12, wherein the cover has a basic shape of a spherical layer with an attachment rim and a recess, wherein the cover is gripped between the first heat sink and the second heat sink.

14. The illumination device as claimed in claim 13,
wherein the first heat sink and the second heat sink abut.

15. The illumination device as claimed in claim 1
wherein the carrier substrate is arranged in front of a widest point of the illumination device.

16. The illumination device as claimed in claim 1,
wherein the illumination device comprises a light emitting diode incandescent lamp retrofit lamp.

17. The illumination device as claimed in claim 1,
wherein the at least one light source comprises at least one light-emitting diode.

18. The illumination device as claimed in claim 7,
wherein the at least one cooling structure comprises one of a cooling strut and a cooling fin.

19. The illumination device as claimed in claim 12,
wherein the illumination device features a diffuser.

20. The illumination device as claimed in claim 14,
wherein the first heat sink and the second heat sink abut in a coded manner.
